(19) United States
(12) Patent Application Publication
(10) Pub. No.: US 2018/0341936 A1
(43) Pub. Date: Nov. 29, 2018

(54) USB Data Card and Method of Using Same

(71) Applicant: Raj Manansingh, Tampa, FL (US)

(72) Inventor: Raj Manansingh, Tampa, FL (US)

(21) Appl. No.: 15/886,177

(22) Filed: Feb. 1, 2018

Related U.S. Application Data
(60) Provisional application No. 62/510,217, filed on May 23, 2017.

(51) Int. Cl. G06Q 20/12; G06F 13/40; G06F 17/30; G06K 7/10

(52) U.S. Cl. CPC G06Q 20/123; G06F 13/4081; G06Q 50/01; G06F 17/30702; G06K 7/10297; G06F 17/30867

(57) ABSTRACT

An card and method are provided whereby the apparatus is preloaded with music, videos, and movies and auto executive bowl files that will connect to a particular website once the USB connector of the card is connected to a computing device having an Internet connection.

### INDEX TO RELATED APPLICATIONS

This application is a non-provisional of and claims benefit to U.S. Provisional Patent Application Ser. No. 62/510,217 filed May 23, 2017 the disclosure of which is incorporated herein by reference in its entirety.

### SUMMARY OF THE INVENTION

The USB Music Card is a medium that holds music, movies and videos from various artists that can be played on any MAC, Windows, tablet, Android phone, or Smart TV. It's a 2-4 mm thick piece of plastic, business card size with a dongle that connects to electronic devices and normally has an artist's album artwork on the front with sponsors on the back. The USB Music Card contains smart links that can let you know when (day, month, year) and where (city, state, and country) the card is being played in live time. Also, there is a 20 mm×20 mm opening in the card that allows for any type of tag or chip (Radio-Frequency identification RFID, Near Field Communication NFC, and/or Bluetooth) to be inserted and sealed in the plastic casing. This allows for the front and back printing to completed first reducing cost and manufacturing time.

As a musician, you need to know when and where your music is being played and sold. USB Music Cards provide the artist the smartest merchandise on the planet! This is the only item that an artist can sell that will give LIVE TIME ANALYTICS! Know when (day, month, year) and where (City, State, Country) your fans are listening to your music. These analytics will help you decide if you need more concerts or live performances in certain parts of the country. Win over corporate sponsors by showing them who and where your demographics are.

An easy to use Menu appears when you plug your customized USB Music Card into any computer.
Music—all your amazing tracks in order with NO internet connection, ads to disrupt the mood, or expensive data charges
Artist Bio—takes your fans to any one or more web pages with all social media links and other albums that can be purchased
Video—include music videos or custom “thank you” videos to your fans for their support
Back Stage—special pictures or videos to your fans as an added bonus for purchasing your album. For example: behind the scenes video clips, special album artwork, unreleased pictures of the band
Sponsors—including your sponsors is a great way to cover your cost and show gratitude for their support
Reward loyal music fans with addition content such as pictures, extra music tracks, or even a personal video thanking them
Get music sponsors by putting their logo on the exterior of the card
Music Sponsors love that there is an introduction video that can be up to 5 minutes when the Card of the invention is first played
Track who is playing your music in LIVE TIME (Country, City, and State)
Easy to sell and distribute at concerts, night clubs, festivals, and trade shows because they are the size of a business card
Gain maximum exposure at shows because it goes around music fans necks with a stylish lanyard
Increase music sales by knowing where your music is selling or if you need to market to certain areas where you music would be best loved
No more guessing if live performances are generating music sales. Know instantly if you are a hit with the crowds!
Plays on all music devices instantly (cars with USB port, computers, MAC's, all Android phones, will pay through your phone's bluetooth or headphone jack)

Near Field Communication. NFC technology allows you to touch your mobile phone to the USB Music Card and allow fans to be taken right to your Profile Page associated with the card of the invention. This is the same technology used to pay at cash registers at time of checkout.

Quick Response Code. A QR Code is placed on your USB Music Card so music lovers can quickly get to a created Profile Page associated with the card of the invention. Once there, they can follow your social media links or purchase other albums. All data is tracked in live time.

Universal Serial Bus. USB allows your USB Music Card to be played on any device that supports the connection. Whether it's a Mac, Windows, Smart TV, tablet, or 95.7% of other computing devices, you can be sure your USB Music Card will play.

In one embodiment, the present invention provides a method by which cards of the present invention will be used as passes to enter trade shows. Advantages include:
1. Quicker entry into trade show because of NFC chips
2. Exhibitors (business selling at trade shows) can now capture attendees information using out NFC chips
3. Exhibitors will have a “note” section for follow ups on each attendee that enters their booth to increase ROI for trade show overhead costs
4. Exhibitors get charge by weight for printed material that is handed out. You will not need to hand out material because all the Exhibitor's pamphlets, brochures, or printed material now can be saved to our USB drive via the UDP chip.

In one embodiment, the present invention is a card for distributing media including any one or all of music, videos and movies said card comprising:

a main card body having substantially flat and parallel upper and lower planar surfaces;
a USB male connector constructed and arranged having a first unfolded configuration whereby said USB connector is substantially within the periphery of the card, and an unfolded configuration whereby said USB connector utilizes a living hinge to extend away from the planar surface of said card and is accessible for insertion into a USB receiving port.

In one embodiment, the present invention is a card including at least one communications device including at least one of Near Field Communication (NFC) chip, Bluetooth communications device, Radio-Frequency identification (RFID) chip, UDP (USB Disk In Package), or combinations thereof.

In one embodiment, the present invention is a method of distributing music, videos, and movies and interacting with patrons of said music said method comprising the steps of: providing a card according to claim 1, whereby said card is preconfigured with music and information, said information including automatically executable instructions to connect to a preselected website when said card is inserted into a USB port of a computing device connected to the Internet; and optionally: accessing said preselected website and uploading information relating to at least one of a place of card acquisition; number of times said preselected website is accessed with a particular card; uploading payment and purchase of any one of music, videos, movies, clothing or promotional items; or combinations thereof.

In one embodiment, the present invention is a method of interacting at a trade show, said method comprising the steps of:

providing a card according to claim 1, whereby said card is preconfigured with information relating to at least one particular trade show or with a user selectable list of trade show information, said information including automatically executable instructions to connect to a preselected website when said card is inserted into a USB port of a computing device connected to the Internet;
exchanging information between attendee card holders and exhibitors using NFC chips in said card;
providing said exhibitors software to interact with said cards to create a “note” section for follow ups on each attendee that enters an exhibitor booth;
optionally, configuring said pre selected website as a communication link between cardholders and exhibitors.

In one embodiment, the present invention provides a method by which cards of the present invention will be used as passes to enter trade shows. Contemplated advantages include:
1. Quicker entry into trade show because of NFC chips
2. Exhibitors (business selling at trade shows) can now capture attendees information using out NFC chips
3. Exhibitors will have a “note” section for follow ups on each attendee that enters their booth to increase ROI for trade show overhead costs
4. Exhibitors get charge by weight for printed material that is handed out. You will not need to hand out material because all the Exhibitor's pamphlets, brochures, or printed material now can be saved to our USB drive via the UDP chip.

In one embodiment, the present invention is a card for distributing media including any one or all of music, videos and movies said card comprising:

a main card body formed of connected top cover and bottom cover having substantially flat and parallel upper and lower planar surfaces;
a USB male connector constructed and arranged having a first unfolded configuration whereby said USB connector is substantially within the periphery of the card, and an unfolded configuration whereby said USB connector utilizes a hinge to extend away from the planar surface of said card and is accessible for insertion into a USB receiving port.

In one embodiment, the present invention is a card including at least one communications device nested within said connected top cover and bottom cover including at least one of Near Field Communication (NFC) chip, Bluetooth communications device, Radio-Frequency identification (RFID) chip, UDP (USB Disk In Package), or combinations thereof.

In one embodiment, the present invention is a method of distributing music, videos, and movies and interacting with patrons of said music said method consisting of the steps: providing a card according to the present invention, whereby said card is preconfigured with music and information, said information including automatically executable instructions to connect to a preselected website when said card is inserted into a USB port of a computing device connected to the Internet; and optionally: accessing said preselected website and uploading information relating to at least one of a place of card acquisition; number of times said preselected website is accessed with a particular card; uploading payment and purchase of any one of music, videos, movies, clothing or promotional items; or combinations thereof.

In one embodiment, the present invention is a method of interacting at a trade show, said method consisting the steps of:

providing a card according to the present invention, whereby said card is preconfigured with information relating to at least one particular trade show or with a user selectable list of trade show information, said information including automatically executable instructions to connect to a preselected website when said card is inserted into a USB port of a computing device connected to the Internet;
exchanging information between attendee card holders and exhibitors using NFC chips in said card;
providing said exhibitors software to interact with said cards to create a “note” section for follow ups on each attendee that enters an exhibitor booth;
optionally, configuring said pre selected website as a communication link between cardholders and exhibitors.

### BRIEF DESCRIPTION OF THE SEVERAL VIEWS OF THE DRAWINGS

FIG. 1A is a top plan of the inside bottom cover according to one embodiment of the present invention.

FIG. 1B is a plan view of the inside top cover according to one embodiment of the present invention.

FIG. 2 is a top view of the dongle door according to one about them in the present invention.

FIG. 3 is an exploded side perspective view of components of one bottom of the present invention.

FIG. 4 is a separated view of the dongle door according to one bottom of the present invention.

FIG. 5 is a rear elevational view of the dongle door according to one embodiment of the present invention.

FIG. 6 is a top plan view according to one embodiment of the present invention.

FIG. 7 is a bottom plan view according to one embodiment of the present invention.

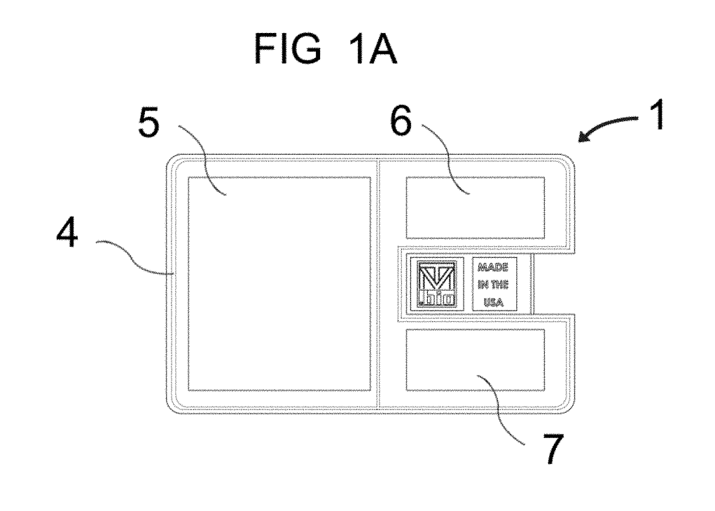

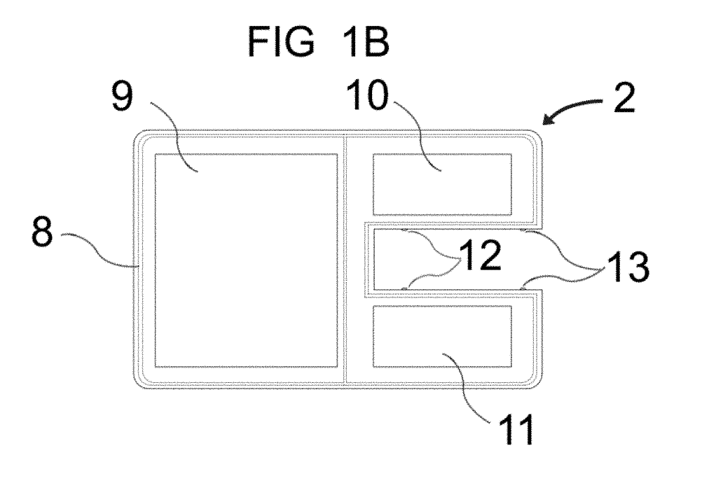

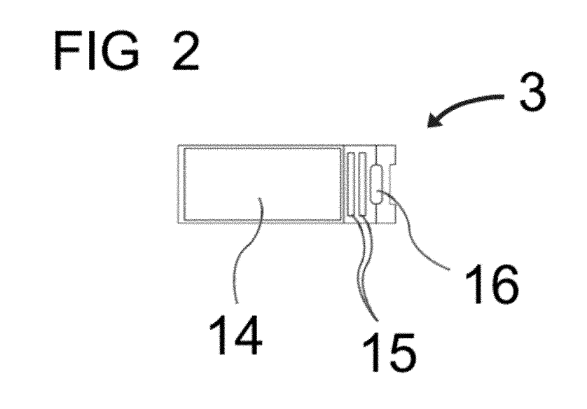

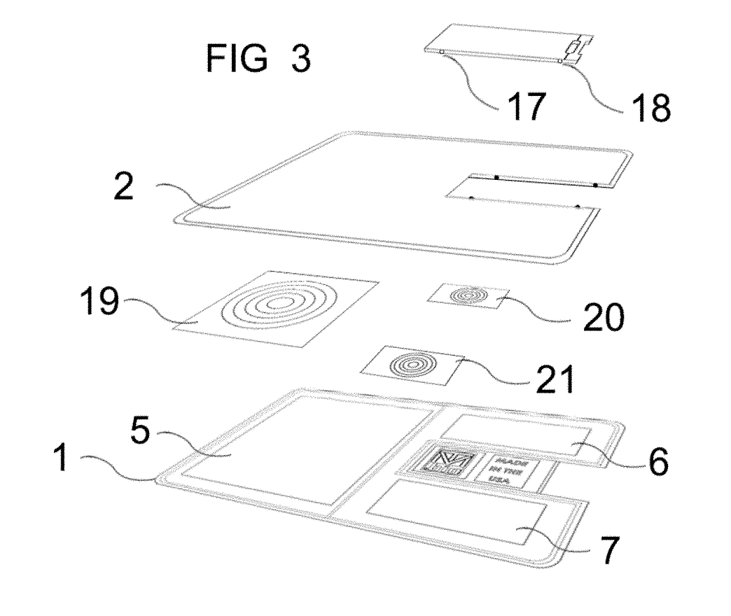

### DETAILED DESCRIPTION OF THE PREFERRED EMBODIMENT

The present invention encompasses each of a card and a method of distributing and promoting music, videos, or movies using said card.

As demonstrated in the various figures, the assembly includes a bottom cover 1 and a top cover 2. Top cover 2 is constructed and arranged with a first pair of protrusions 17a and a second pair of protrusions 18a that are constructed and arranged to meet with first socket 17 and second socket 18 on dongle door assembly 3. In one embodiment, bottom cover one is constructed and arranged with a peripheral groove 4 that is constructed and arranged to mate with tongue protrusion 8 on top cover 2. Bottom cover 1 further has formed there with a first pocket 5 constructed and arranged to hold any of a Radio-Frequency identification (RFID) chip(s,) Bluetooth chip(s), or any other chips that allow transfer of data through wireless communication. Top cover 2 has first pocket 9 congruent with first pocket 5 of bottom cover 1. Bottom cover 1 further has second pocket 6 and third pocket 7 that are congruous with top cover first pocket 10 and top cover second pocket 11 constructed and arranged to hold any of a Radio-Frequency identification (RFID) chip(s,) Bluetooth chip(s), or any other chips that allow transfer of data through wireless communication. In one embodiment, bottom cover 1 has a peripheral groove congruous with the groove on top cover 2.

Door dongle 3 is forms with door dongle pocket 14 for securing UDP chip or any other USB type chip anti-slip thumb grooves 15 and cavity 16 configured for lanyard or any other clip and hook device.

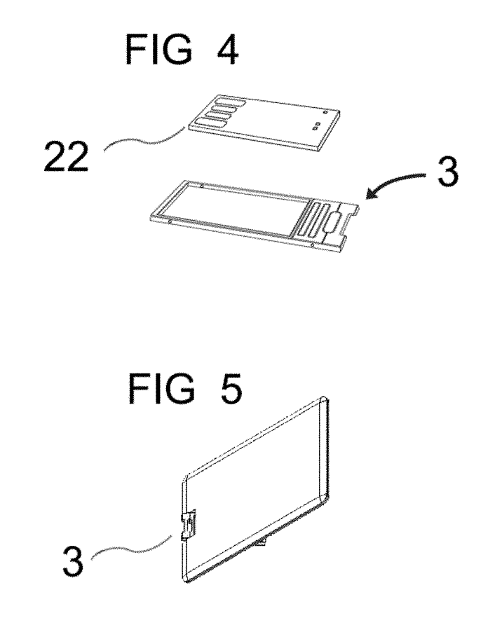

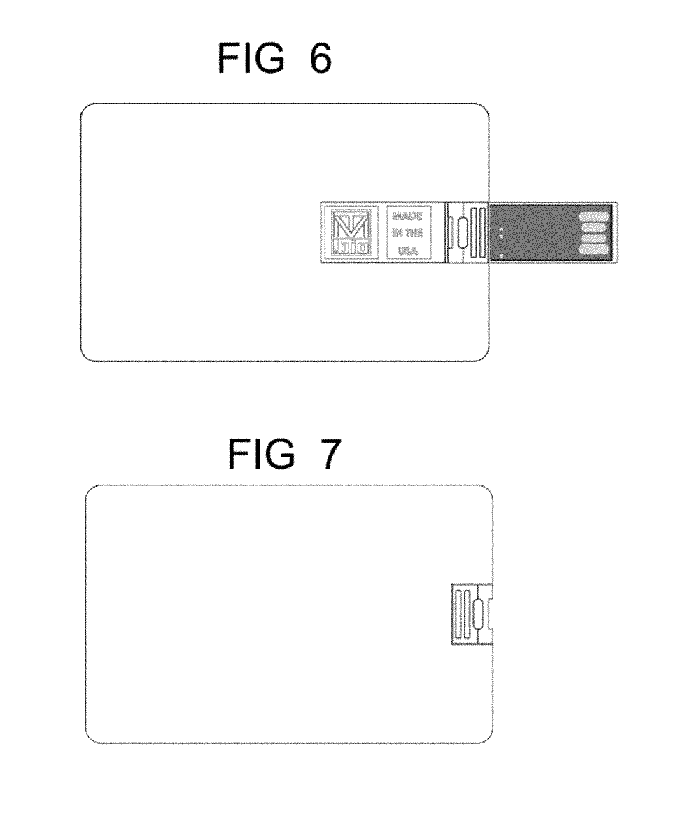

Although FIG. 4 provides for Near Field Communication (NFC) chip 19, Bluetooth chip 20, and Radio-Frequency identification (RFID) chip 21, the chips can be formed configured and positioned in any combination and are not limited to the placement set forth in the figures. UDP (USB Disk In Package) or any other form of USB chip 22 are formed to mate with door dongle 3.

As generally understood, the invention is configured to selectively store movies, music, and/or other forms of data. This is a replacement for the cd and dvd.

In a preferred embodiment, the card assembly of the invention is between 2 mm and 5 mm thick when each of bottom cover 1 and top cover 2 are attached on to the other. In another embodiment, the card assembly is 3-4 mm thick.

Another advantage is that printing of indicia can be done first and the decision of which chip(s) can be determined afterwards. With other cards printing is the last step and no changes can take place after that. This will save money for our clients because they can purchase, print, and hold inventory on a large scale instead of small costly custom runs.

In one embodiment, the card will be made out of ABS (Acrylonitrile Butadiene Styrene).

In one embodiment, the bottom cover 1 and top cover 2 are attached to form an assembly by either gluing or sonic welding.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A card for distributing media including any one or all of music, videos and movies said card comprising:
a main card body formed of connected top cover and bottom cover having substantially flat and parallel upper and lower planar surfaces;
a USB male connector constructed and arranged having a first unfolded configuration whereby said USB connector is substantially within the periphery of the card, and an unfolded configuration whereby said USB connector utilizes a hinge to extend away from the planar surface of said card and is accessible for insertion into a USB receiving port.

2. The card of claim 1 including at least one communications device nested between said connected top cover and bottom cover including at least one of Near Field Communication (NFC) chip, Bluetooth communications device, Radio-Frequency identification (RFID) chip, UDP (USB Disk In Package), or combinations thereof.

3. A method of distributing music, videos, and movies and interacting with patrons of said music said method comprising the steps of:
providing a card according to claim 1, whereby said card is preconfigured with music and information, said information including automatically executable instructions to connect to a preselected website when said card is inserted into a USB port of a computing device connected to the Internet; and
optionally: accessing said preselected website and uploading information relating to at least one of a place of card acquisition; number of times said preselected website is accessed with a particular card; uploading payment and purchase of any one of music, videos, movies, clothing or promotional items; or combinations thereof.

4. A method of interacting at a trade show, said method comprising the steps of:
providing a card according to claim 1, whereby said card is preconfigured with information relating to at least one particular trade show or with a user selectable list of trade show information, said information including automatically executable instructions to connect to a preselected website when said card is inserted into a USB port of a computing device connected to the Internet;
exchanging information between attendee card holders and exhibitors using NFC chips in said card;
providing said exhibitors software to interact with said cards to create a “note” section for follow ups on each attendee that enters an exhibitor booth;
optionally, configuring said pre selected website as a communication link between cardholders and exhibitors.
